(19) United States
(12) Patent Application Publication
(10) Pub. No.: US 2010/0240786 A1
(43) Pub. Date: Sep. 23, 2010

(54) COMPATIBILIZERS FOR IMPROVING THE SHELF LIFE OF POLYOL MIXTURES

(75) Inventors: Martin GLOS, Borken (DE); Ruediger Landers, Essen (DE); Matthias Naumann, Greensboro, NC (US); Eva Emmrich, Essen (DE)

Correspondence Address: FROMMER LAWRENCE & HAUG, 745 FIFTH AVENUE- 10TH FL., NEW YORK, NY, 10151, US

(73) Assignee: Evonik Goldschmidt GmbH, Essen (DE)

(21) Appl. No.: 12/725,540

(22) Filed: Mar. 17, 2010

(30) Foreign Application Priority Data
Mar. 17, 2009 (DE) 102009001595.7

(51) Int. Cl. C08J 9/00; C09K 3/00

(52) U.S. Cl. 521/170; 252/182.24; 252/182.27

(57) ABSTRACT

Compatibilizers for mutually immiscible polyol compositions, characterized in that they comprise dispersed particles, and processes for production of these and their use in polyurethane foams.

This application claims benefit under 35 U.S.C. 119(a) of German patent application DE 102009001595.7, filed on 17 Mar. 2009.

Any foregoing applications including German patent application DE 10 2009 001595.7, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The invention relates to novel compositions composed of particle and carrier media as compatibilizers for improving the shelf life of at least two mutually immiscible polyols, to a process for the production of the said compatibilizers and to the use of the resultant compatibilized polyol mixtures for the production of foams via reaction of the polyol mixtures with polyisocyanates to form polyurethane foams and/or polyisocyanurate foams and/or polyurea foams.

For the purposes of this application, homogeneous mixtures are those composed of two or more mutually immiscible polyol components which have no macroscopically visible phase separation. These polyol mixtures can comprise solids in dispersed form or else can be emulsions which do not undergo any phase separation or which undergo only delayed phase separation.

Polyol mixtures used in industry are composed of at least two, but often markedly more than two, polyol components which have different polarity or different levels of hydrophilic properties, the consequence of these factors being that the components are to some extent immiscible or are mutually miscible only to some extent. Phase separation of these mixtures leads to problems during use, for example during foaming to give polyurethane foams.

Compositions which are composed of particles and of a carrier medium and which promote the formation of homogeneous polyol mixtures of the above type are termed compatibilizers in this application. The polyol mixtures can comprise not only these compatibilizers but also, if appropriate, for example, water, other solvents, blowing agents, solids, or else other additives and auxiliaries.

Polyol mixtures per se are known in the form of polyol component for the production of polyurethane foams in the prior art.

The compatibilizers are therefore used for the compatibilization or homogenisation of the polyols where these are not readily miscible. The term compatibilization is used as a term found in the technical literature, although the procedure is similar in principle to homogenization or emulsification. A compatible polyol mixture therefore appears macroscopically to have a single phase.

Polyurethane foams are used in a wide variety of applications, examples being found in refrigerators, insulation panels, automobile seats or mattresses, for purposes of thermal insulation, energy absorption and absorption of sound. It is therefore necessary to produce polyurethanes with different and precisely adjusted specifications/parameters. Among these important parameters are, for example, mechanical properties, density and moulding time.

The industrial production of polyurethane foams uses polyols and in particular polyol mixtures as reactive component for the reaction with polyisocyanates. The properties of the resultant foam are particularly dependent on the structure and the chemical constitution of the polyol mixtures used.

The PU industry (foam sector) uses a very wide variety of types of polyol. By way of example, a distinction is made between polyether polyols and polyester polyols, as a function of the chemical structure of the compounds.

Further distinctions are made among the polyols as a function of the synthetic route used for this important class of compound. By way of example, the polyols can be based on renewable raw materials and thus comply with the modern concept of renewability.

These polyols produced from renewable raw materials are therefore termed NOPs (natural oil based polyols).

Among these are representatives of, for example, vegetable oils or extracts of vegetable raw materials, the production of which needs no, or only very few, steps of chemical modification/synthesis.

EP 0 543 250 (U.S. Pat. No. 5,384,385) describes a blend based on amidines and comprising active hydrogen and stabilized with respect to demixing.

U.S. Pat. No. 4,485,032 describes compositions composed of incompatible high-molecular-weight polyols and ethylene glycol, which are compatibilized, i.e. rendered mutually miscible, via addition of urea and of substituted ureas.

Examples of current trends are the use of naturally based polyols (NOPs), which are mixed with conventional petroleum-based polyols, or, more generally, the use of at least two polyols which have different polarities, e.g. due to different contents of ring-opened ethylene oxide. In both cases, a problem that occurs is that the polyols for foaming (processing) are then not mutually soluble, and the polyol mixture is an emulsion or dispersion which often has only limited shelf life; for the purposes of the application, mixtures of this type are termed mutually incompatible.

US 20070238800 therefore describes a composition which is reactive towards isocyanates and which has good shelf life, comprising at least 10% of a vegetable-oil-based polyol; nonylphenol ethoxylate having at least 25 EO (ethylene oxide units) is described in that document for improving shelf life.

That document describes only complex mixtures of polyether polyols with castor-oil-based polyol, comprising at least five components. The method described in that document cannot solve the solubility problems described in this application in connection with polyester polyols and vegetable-oil-based polyols. An exacerbating factor is that, alongside the use of vegetable-oil-based polyols, there is a requirement for concomitant use of synthetic polyols.

DE 2341294 (U.S. Pat. No. 4,029,593) describes mixtures of mutually immiscible polyhydroxy polyethers, which can be converted to a single-phase system via addition of inert surfactant inorganic substances with a specific surface area of from 10 to 800 m²/g. That document mentions that high-rotation-rate stirrers, i.e. high shear forces, are needed in order to incorporate the inorganic substances into the mixtures. However, the producers of polyol mixtures often do not have any suitable stirrers available for applying shear forces of this type on an industrial scale. Furthermore, the handling of the solids described in that document, which often have very low bulk densities, is very costly. This high technical cost is a major disadvantage of the said process.

Particularly when an appropriate polyol mixture cannot be used immediately after it has been produced, or when there is no possibility of stirring it continuously until it is used in order to retain its homogeneity, there is a pressing need for an appropriate shelf life.

Polyol mixtures for foaming are often mixed with all of the necessary components other than the isocyanate, this mixture being transported and stored until foaming takes place. To this end, the necessary substances known in the prior art can be added to the polyols, examples being blowing agents, stabilizers, catalysts, dyes, flame retardants, and also other auxiliaries needed for the processing, production and use of the foam. These polyol mixtures comprising additives are also termed “systems” or, in Europe, “A component”.

The term polyol mixture used below means not only the polyol mixtures themselves but also mixtures which comprise the additives described above.

If the polyol mixture is to be versatile, it is necessary that it can be directly used at minimum cost wherever and whenever it is needed. A particular implication of this is that the polyol mixture be homogeneous, as defined above.

This is particularly important when the polyol mixtures cannot be used directly but instead have to be stored under the varying conditions of transport and storage that arise in industry (exposure to adverse temperatures, changing temperatures, no possibility of agitation, etc.).

Methods that are conventional in industry for producing and retaining homogeneity or preventing phase separation of the systems have consisted in using complicated mixers, or constant pumped circulation, in order to keep the components in motion in the storage tanks and distribution tanks. However, these technically complicated measures are not always certain to ensure that separation of the components is prevented and that adequate homogenization is provided.

A consequence of inadequate homogenization in the mixture with the polyisocyanates is that the regions of inhomogeneity in the reactive mixture do not then have the correct stoichiometry, i.e. the prescribed ratio of the polyols in the polyol mixture. In such cases, compliance with the important necessary parameters for components appropriately matched to one another then becomes uncertain, the result being production of defective polyurethane foams.

Attempts have therefore been made to overcome the said disadvantages by using dispersing agents and/or emulsifying agents.

By way of example, WO 2005/085310 (US 2007-0270518) proposes a prepolymer composition in particular for the production of polyurethane filler foams and of polyurethane insulation foams, where the prepolymer composition comprises polyurethane prepolymers from the reaction of a first component, comprising hydrophobic polyester polyols having at least two hydroxy groups, and a second component, comprising polyisocyanates having at least two isocyanate groups, characterized in that the polyester polyols are at least to some extent transesterification products from vegetable or animal oils with aromatic di- and/or tricarboxylic acids, their esters or anhydrides, or else polyols.

According to EP 0909792, single-component polyurethane synthesis compositions are described comprising a synthetic polymer (T) as emulsifier, and also two polyols, which are not otherwise mutually miscible.

The resultant mixtures encompass very complex synthetic polymeric systems, accessible only via complicated synthesis.

The compatibilizers listed in the prior art are either difficult to incorporate into the polyol mixtures or can be produced only by way of complicated multistage syntheses, and moreover the mixtures comprise components that cannot be used to the same extent in all of the industrial application sectors of polyurethane foams, or that indeed are incompatible.

It was an object of the present invention to overcome the disadvantages of the prior art and to provide novel compatibilizers for immiscible polyol compositions.

Surprisingly, it has been found that dispersed particles are capable of achieving this object.

The invention therefore provides compatibilizers comprising a particle dispersion in a carrier medium, also termed dispersion phase, and the production of these and the use of these as homogenizers for at least two mutually immiscible polyols, characterized in that particles are used which assume an interface-stabilizing function, and thus avoid phase separation and improve the shelf life of the polyol mixture.

It is assumed that the dispersion phase, the carrier medium, dissolves in one of the liquid phases of the incompatible polyol mixture and then the “liberated” particles migrate to the interface, where they then have emulsifying action.

Particles that can be used as constituent of the compatibilizers are those selected from the group of the semimetal oxides, metal oxides (for example of Al, Si, Ti, Fe, Cu, Zr, B, etc.), mixed oxides, and of the nitrides, carbides, hydroxides, carbonates, silicates, silicone resins, silicones and/or silica and/or organic polymers, where all of the abovementioned classes of particle can, if appropriate, have been surface-modified, for example hydrophobized or partially hydrophobized. Examples of materials that can be used for the hydrophobization or partial hydrophobization process are at least one compound from the group of the silanes, siloxanes, quaternary ammonium compounds, cationic polymers and fatty acids or anions of these.

Furthermore it is preferable to use particles that are, in at least one dimension, nanoscale, or to use nanostructured particles, or to use nanoobjects, in the compatibilizers.

For the purposes of the present invention, nanoscale particles, nanostructured particles or nanoobjects are materials which are nanoscale in either one, two or three external dimensions, preferably having a size of from 1 to 100 nm in at least one dimension, examples being nanoplatelets, nanorods and nanoparticles. In the present invention, nanostructured particles are materials or, respectively, particles which have an inner nanoscale structure. Examples of typical representatives are aggregates and agglomerates of nanoobjects. A property of the particles to be used according to the invention is that by virtue of their surface structure and/or modification thereof they migrate to the interface between mutually immiscible liquids, where they assume an interfacially active function analogous to that of an emulsifier.

The surface of the particles can have been completely or partially hydrophobized. An example of a measure of hydrophobization is the methanol index or flotation index, demonstrating the (water) wettability of the particle in respect of a particular medium: the methanol index or the THETA contact angle method in accordance with the Lukas-Washburn equation provide a way of at least approximately deriving the level of hydrophobic properties of a particle surface, for example as described in DE 10260323 (US 2004-0131527). According to DIN EN ISO 862: 1995-10, the level of hydrophobic properties is defined as the constitutional property of a molecule or a molecular group of behaving in an exophilic manner with respect to water, i.e. the materials exhibit a tendency not to penetrate into water or to migrate out of the aqueous phase.

In order to assess the compatibilizers of the invention and the resultant homogenized, compatibilized polyol mixtures, the demixing/creaming of a (compatible) polyol mixture is monitored at constant temperature as a function of time. If phase separation is macroscopically discernible within a period of less than 24 hours the result is unsatisfactory. On the other hand, the polyol mixture is deemed compatibilized by addition of the compatibilizers of the invention if the amount of phase separation occurring within a period of 24 hours at room temperature is less than 6 percent by volume, preferably less than 3 percent by volume and in particular less than 1.5 percent by volume.

The particles are very particularly preferably of inorganic type, if appropriate with organic surface-modification.

Particularly preferred constituents of the compatibilizers are particles with average primary particle size <1000 nm, in at least one dimension, preferably <500 nm and particularly preferably from 1 to 100 nm. The primary particle size can be determined in the manner known to the person skilled in the art, for example by way of SEM, TEM, DLS or static light scattering, etc. It is preferable to determine the primary particle size via optical evaluation of a transmission electron micrograph.

Suitable materials for stabilizing polyol mixtures are nanoscale, predominantly inorganic particles, e.g. silica particles, which by way of example are obtainable in the form of sols or dispersions. Materials likewise suitable are oxidic silica particles, e.g. fumed Aerosils, precipitated Sipernat products or silica particles produced by the Stöber process.

Co-emulsifiers that can be used in the process of the invention are generally cationic, nonionic, amphoteric or anionic surfactant substances that are adsorbed onto the particles. Co-emulsifiers that can be used in the process of the invention for particles with negative zeta potential are therefore in particular compounds selected from the group of the cationic surfactants. Examples of cationic co-emulsifiers that can be used are those available with product names VARISOFT 470 P, VARISOFT TC-90, VARISOFT 110, VARISOFT PATC, AROSURF TA-100, ADOGEN 442-100 P, ADOGEN 432, ADOGEN 470, ADOGEN 471, ADOGEN 464, VARIQUAT K 300, VARIQUAT B 343, VARIQUAT 80 ME, REWOQUAT 3690, REWOQUAT WE 15, REWOQUAT WE 18, REWOQUAT WE 28 or REWOQUAT CR 3099 from Evonik Goldschmidt GmbH (the capitalized product names being registered trade marks of Evonik Goldschmidt GmbH). A preferred cationic co-emulsifier used in the process of the invention is cetyltrimethylammonium bromide or cetyltrimethylammonium chloride (VARISOFT 300) or VARISOFT PATC. Other co-emulsifiers that can be used are trialkylamines, such as tertiary amines, e.g. trioctylamine, dimethyldodecylamine, dimethylhexadecylamine, dimethyldecylamine, dimethyloctadecylamine, dimethyllaurylamine, dimethylstearyl-amine or didecylmethylamine. For particles with positive zeta potential, particular co-emulsifiers that can be used are those selected from the group of the anionic surfactants, e.g. sodium lauryl sulphate, sodium lauryl ether sulphate, sulphosuccinates, such as REWOPOL SB DO 75, alkyl ether phosphates, fatty acid anions, N-acylamino acids, olefinsulphonates or alkylbenzenesulphonates. The co-emulsifiers can promote or optimize the action of the particulate compatibilizer.

The compatibilizers of the invention are preferably produced in a form substantially free from other co-emulsifiers. If additional co-emulsifiers are nevertheless used, the amount used is from 0 to 10% by weight, based on the content of the dispersed particles, preferably from 0.05 to 8% by weight and particularly preferably from 0.2 to 5% by weight.

The invention further provides compositions which are free from non-particulate emulsifiers.

If, for reasons of application technology, it is not possible to omit a non-particulate emulsifier, the amount of these present is from >0 to less than 10% by weight.

It is also possible to use, for example, particles modified with silanes and with organopolysiloxanes. Preference is given here to use of oxidic particles, e.g. fumed or precipitated silica particles or silica particles produced by the Stöber process, but this does not exclude the use of other particulate materials.

This type of surface-modification can by way of example be achieved by using trimethylsiloxy-endcapped dimethylpolysiloxanes, cyclic dimethylpolysiloxanes, α,ω-dihydroxypoly-dimethylsiloxanes, cyclic methylphenylsiloxanes, trimethylsiloxy-endcapped methylphenylpolysiloxanes and/or trimethylsiloxy-endcapped dimethylsiloxane-methylphenylsiloxane copolymers, if appropriate in the presence of a suitable catalyst (such as ammonium carbamate or alkali metal hydroxides), if appropriate together with elevated temperatures.

Examples of possible surface-modifiers are trimethyl-chlorosilane, hexamethyldisilazane, (meth) acryloxypropyltri-alkoxysilanes, aminopropyltrialkoxysilanes, polydimethyl-siloxanes, polysiloxanes, where these bear Si—H groups, or pure carboxylic acids, chelating agents or fluoropolymers. Another possibility is to use silanes having at least partially fluorinated alkyl moieties, an example being 3,3,4,4,5,5,6,6,7,7,8,8,8-tridecafluorooctyl or 3,3,3-trifluoropropyl groups.

If silanes are used for the surface-modification process, it is preferably possible to use hydrolysable organosilanes which also have at least one non-hydrolysable moiety. Silanes of this type are represented by the general formula (I)

RₙSiX₍₄₋ₙ₎ (I)

where
R=identical or different non-hydrolysable groups,
X=identical or different hydrolysable groups or hydroxy groups and
n=1, 2, 3 or 4.

The hydrolysable groups X in the general formula (I) can by way of example be H, halogen (F, Cl, Br, I), alkoxy (preferably methoxy, ethoxy, isopropoxy, n-propoxy or butoxy), aryloxy (preferably phenoxy), acyloxy (preferably acetoxy or propionyloxy), acyl (preferably acetyl), amino, monoalkylamino or dialkylamino groups. The non-hydrolysable moieties R in the general formula (I) can moreover be moieties either having or not having functional groups. R in the general formula (I) not having functional groups can therefore by way of example be an alkyl, alkenyl, alkynyl, aryl, alkylaryl or aralkyl moiety. The moieties R and X can, if appropriate, have one or more of the usual substituents, such as halogen or alkoxy.

Surface-modification with organopolysiloxanes can be achieved by a covalent or adsorptive method. Examples of these classes of substance are organopolysiloxanes modified with terminal and/or pendant polyether or polyester chains. It is equally possible to use monofunctional polysiloxanes for surface-modification of the particles, examples being trimethylsilyl-endcapped α-halogen-, α-alkoxy- and α-hydroxydimethylpolysiloxanes.

The present invention further provides a process for the production of the compatibilizers of the invention, by incorporating the particles into the carrier medium.

The particles of the invention are generally very fine-grain materials which exhibit severe dusting and are therefore difficult to handle. Specialized apparatuses are needed for this purpose and these are generally not available to many producers of polyol mixtures or would burden them with additional capital expenditure.

High shear forces are generally used to incorporate the particles into the carrier medium. The methods known from the prior art for incorporation of solids into liquids can be used here, for example those using dispersers, mills (bead mill or jet mill), extruders or kneaders. If the incorporation process is carried out at an elevated temperature, the carrier media used can also comprise substances which are solid at room temperature.

Incorporation of the particles into a carrier medium avoids the handling of any fine-particle solids during the subsequent use of the compatibilizer, with the attendant disadvantages such as dusting, metering problems caused by low-density fine-particle solids, inhalation toxicity or static charging.

As function of the process used, the compatibilizers can by way of example take the form of viscous liquids, pastes or granules.

It is therefore a simple matter to incorporate the compatibilizers by stirring into the polyol mixture to be compatibilized. This process does not require any specialized stirrer assemblies, because it does not need high shear forces. The compatibilizers of the invention therefore provide a marked improvement and simplification of the production of mixtures with good shelf life composed of immiscible polyols.

There is no need for high shear forces during incorporation of the compatibilizer of the invention. Accordingly, it is possible to use stirrer units and stirrers which by way of example are available in normal tanks for the production of polyol mixtures.

The viscosity of the compatibilizers of the invention, comprising at least the particles and the carrier medium, is from 5 to 50 000 mPas at 80° C. Features common to the compositions are that they eliminate the problem of dusting and that, at room temperature, by way of example, they take the form of a viscous liquid or indeed, if appropriate, can be further processed to give granules that are easy to meter.

Carrier media that can be used are any of the substances suitable for converting the particles to a handlable form and that do not have any attendant disadvantages in subsequent use of the polyol mixture for the production of a foam.

The carrier medium must be compatible (or miscible) with at least one of the polyols, so that the compatibilizer produced therewith can be incorporated into the incompatible polyol mixture.

The particles are “liberated” only when the compatibilizer is incorporated into the polyol mixture, and their emulsifier action then becomes effective.

For the purposes of this invention, compatibility means that a mixture composed of various components does not separate by creaming, settling or phase separation within the period under consideration.

Examples of substances that can be used here are any of those also used as polyol component in polyurethane foam production. Examples of these are polyether polyols, polyester polyols, or else polyols based on renewable raw materials, known as natural oil based polyols (NOPs). However, it is also possible to use, for example, high-molecular-weight polyols which at room temperature are highly viscous or solid. By way of example these can be polyether polyols with high molar mass or with high contents of oxyethylene units. By way of example, pure polyethylene glycols with average molar mass 1000 g/mol are solid at room temperature.

Examples of polyether polyols that can be used are copolymers composed of ethylene oxide and propylene oxide, where these are based on mono- or polyfunctional starter molecules. Examples of materials that can be used are: polyether PPG 2290, polyether PPG 2470, polyether BP 1042 or polyether ALP 1418 from Evonik Goldschmidt or polyglycol B 11 grades, polyglycol D grades or polyglycol P 41 grades from Clariant, or else Pluronic grades, such as Pluronic PE 3100, Pluronic PE 4300, Pluronic PE 6400, Pluronic PE 6800, Pluronic PE 9200, Pluronic PE 10500, Pluronic RPE 1720, Pluronic RPE 1740, Pluronic RPE 2035 from BASF.

Polyols which have high content of oxyethylene units are equally suitable as carrier medium. The melting point of the said polyols is higher than that of the polyols traditionally used in the foaming process. It can be advantageous to use these EO-rich polyols in the production of the compatibilizers if the particles are incorporated at elevated temperatures at which the polyol is liquid, the product at room temperature then being a low-tack solid.

Examples of materials that can be used here are alcohol- or amine-based ethoxylates, e.g. butyl glycol, butyl diglycol, alkylphenol ethoxylates, e.g. Arkopal grades from Clariant, or polyglycol M grades from Clariant, such as polyglycol M 2000 or polyglycol M 1000, Lutensol grades from BASF, Tagat grades, such as TAGAT R 200, TAGAT CH 40, TAGAT CH 60, TAGAT V 20 or Tegoalkonol TD 6 or Tegoalkanol TD 12, or Varonic T 202, Varonic K 205 or Varonic T 215 from Evonik Goldschmidt.

Other materials that can be used as carrier media are pure polyethylene glycols (PEG), examples being PEG 400, PEG 600, PEG 1000, PEG 2000, PEG 6000, PEG 8000, PEG 12000, PEG 20000 or PEG 35000 (all of which are obtainable from Clariant).

It is equally possible to use suitable substances known by way of example from cosmetic or industrial applications. By way of example, these can be esters, amides or carbonates, examples being phthalates, trimellitates, adipates, or those known as dibasic esters, isononanoates, octoates, nonanoates, isononanoates, benzoates, stearates, cocoates, caprates or ricinoleates, available by way of example with the following product names:

TEGOSOFT GMC 6, TEGOSOFT GC, TEGOSOFT CI, TEGOSOFT CT, TEGOSOFT OS, TEGOSOFT DO, TEGOSOFT HP, TEGOSOFT E, TEGOSOFR G 20, TEGOSOFT TIS, TEGOSOFT TN, TEGOSOFT CR, TEGOSOFT TN, TEGOSOSOFT DEC, TEGOSOSFT P, TEGOSOFT M, TEGOSOFT MM, TEGOSOFT PC 31, TEGOSOFT LSE 65 K, ISOLAN GI 34, ISOLAN GO 33, ISOLAN IS, ISOLAN GPS, TEGIN O V, TEGO SML, TEGO SMO V, TEGO SMA, TEGO STO VARONIC APM, TEGOSOFT CR, TEGOSOFT TIS, TEGOSOFT DEC, REWOMID C 212, REWOMID DC 212, REWOMID DC 212 S, REWOMID DL 240, REWOMID SPA, REWOMID IPP 240, REWOCID DU 185 SE, REWOPAL V 3646, REWOPAL V 3454, REWOPAL V 3564, REWODERM LI S 80, REWODERM LI 63 from Evonik Goldschmidt, or as VESTINOL INB, VESTINOL 9 from Evonik Degussa, or as Palatinol grades, Palamoll grades, Plastomoll grades from BASF or as Jayflex DINP, Jayflex DIDP, Jayflex DIUP from Exxon.

Other materials that can be used as carrier media are any of the substances known to the person skilled in the art and used as auxiliaries and additives in a polyurethane foam composition in order to exert an effect on the production and use of the polyurethane foam.

Auxiliaries and additives here are inter alia blowing agents, stabilizers, catalysts, flame retardants, pigments, dyes and other substances, of which the following non-exclusive examples may be mentioned: biocides, antistatic agents, etc., where these are necessary for the production and use of the polyurethane foam.

In accordance with the laws that are familiar to the person skilled in the art in relation to the miscibility of incompatible phases, particles located at the interface between two phases should be incompatible with the inner phase and have only very little compatibility with the outer phase.

Surprisingly, for the purposes of this invention it has been found that the particles can be dispersed in a carrier medium which by way of example is already present in the system in the form of one of a plurality of polyol components.

The invention also provides the use of one of the mutually immiscible polyol components as carrier medium for the production of the compatibilizer. As a function of the application sector, it is possible to select either the more polar or else the less polar polyol component as carrier medium.

During production of the compatibilizers via incorporation of the particles into the carrier medium, it can be advantageous to use dispersing agents, for example in order to maximize the content of particles in the formulation or to minimize the viscosity of the formulation.

Dispersing agents that can be used are the substances known from the prior art, examples being ionic, nonionic or amphoteric compounds having surfactant character. Examples of suitable materials are the following dispersing agents produced by Evonik Goldschmidt: TEGOMER® DA and TEGODISPERS® grades.

This invention further provides the compositions composed of one or more carrier media and of the compatibilizing particles in the form of compatibilizer which has good shelf life and which is added to the immiscible polyol mixtures. It is also possible to use mixtures of a plurality of different types of compatibilizing particles.

This invention further provides the advantageous use of the compatibilizers in the form of compositions composed of one or more carrier media and of the compatibilizing particles, added to the immiscible polyol mixtures for purposes of homogenization.

Particular preference is given here to the use of oxidic particles, e.g. fumed or precipitated silica particles or silica particles produced by the Stöber process. The former are produced by way of example in the form of Aerosils® from Evonik Degussa. These materials are by way of example fumed silica or fumed metal oxides, examples being Aerosil A 200, Aerosil R 202, Aerosil R 805, Aerosil R 972, Aerosil R 974, Aerosil R 8200, Aerosil R 9200, Aeroxid Alu C or Aeroxid Alu C 805. Aerosil and Aeroxid are registered trade marks of Evonik Degussa.

It is particularly preferable that dispersing agents and auxiliaries and additives for the PU foam are omitted in the compatibilizer of the invention, and that the compatibilizer is therefore composed of the particles and polyols as carrier medium.

Preferred solid carrier media are polyether polyols having high content of oxyethylene units.

Preferred liquid carrier media used are carboxylic esters known from cosmetic applications (abovementioned TEGOSOFT® grades).

The compatibilizers are incorporated by stirring, using conventional laboratory stirrer devices, e.g. magnetic stirrer rods or blade stirrers. There is generally no need for high shear forces. If necessary, the mixtures were heated to temperatures of up to 100° C., preferably less than 90° C., particularly preferably up to 70° C., in order to incorporate the compatibilizers. After the compatibilized polyol mixture has been cooled, it remains homogeneous, with good shelf life.

For the purposes of this application, a mixture is said to have good shelf life if no phase separation can be discerned within a period of 48 hours at 25° C.

As a function of type and content of particles and of carrier media in the compatibilizer, the material can be a liquid or a solid, and it is also possible that the composition is a formulation having the consistency of a paste. Accordingly, the compatibilizers of the invention can by way of example also take the form of pastes or granules.

The content of particles in the compatibilizers can be within the range from 1 to 70% by weight, preferably from 5 to 60% by weight, particularly preferably from 10 to 50% by weight.

The invention further provides homogeneous polyol mixtures comprising the compatibilizers of the invention and, if appropriate, further auxiliaries and additives.

The invention further provides homogeneous polyol mixtures comprising polyols based on renewable raw materials, in particular vegetable-based polyols, if appropriate in a mixture with polyesterdiols or with polyester polyols.

The invention further provides polyol mixtures composed of polyester polyols and of polyols based on renewable raw materials, in particular vegetable-based polyols, for the production of PU foams, if appropriate comprising further auxiliaries and additives.

The invention further provides polyol mixtures comprising compatibilizers comprising at least two mutually immiscible polyether polyols with different content of oxyethylene units for use in the production of polyurethane foams and/or polyisocyanurate foams and/or polyurea foams, if appropriate comprising further auxiliaries and additives.

This invention further provides the advantageous use, in the polyol compositions, of at least one polyol produced from renewable raw materials, and it is preferable that all of the polyols of the compatibilized mixture have been produced from renewable raw materials.

With use of the compatibilizers, the homogeneous mixtures can be used to give (homogeneous) reactive mixtures composed of:

(I) the homogeneous polyol mixtures comprising the said compatibilizers and, if appropriate, further auxiliaries and additives, and
(II) one or more isocyanates.

The invention further provides compatibilized polyol mixtures which are suitable on reaction with polyisocyanates for the production of polyurethane foams and/or polyisocyanurate foams and/or polyurea foams.

The invention further provides polyurethane foams and/or polyisocyanurate foams and/or polyurea foams, produced with use of the compatibilized polyol mixtures.

The invention further provides the polyol mixtures stabilized via the addition of the compatibilizers of the invention with respect to phase separation, where the polyol mixtures can, if appropriate, also comprise further auxiliaries and additives.

It is particularly preferable that the compatibilizers of the invention are used in polyol mixtures which comprise polyester polyols and polyols based on naturally occurring oil (NOPs), since when these two classes of polyols are mixed they often have a tendency towards phase separation.

Mixtures of this type are often used in the production of rigid polyurethane foams or rigid polyisocyanurate foams.

Preference is also given to the use of the compatibilizers of the invention in the polyether polyol mixtures the individual components of which have different polarities, therefore being mutually immiscible, the result of this then being separation of the polyol mixture into a plurality of phases. By way of example, this can result from different content of oxyethylene units (polyethylene glycol).

Mixtures using compatibilizers of the invention can therefore also be used advantageously in the production of flexible foam systems; these have particular mechanical properties, e.g. viscoelasticity or high elasticity. Agitation has hitherto been the only method of retaining homogeneity in these (inhomogeneous) mixtures.

Any of the suitable polyols can be used to produce the foams. The materials here can be polyether polyols or polyester polyols, where these typically bear from 2 to 60H groups per molecule and can contain not only carbon, hydrogen and oxygen but also heteroatoms, such as nitrogen, phosphorus or halogens. In accordance with the properties demanded from the foams, specialized polyols are used, for example as described in:

US 2007/0072951 A1, WO 2007/111828 A2, US 2007/0238800, U.S. Pat. No. 6,359,022 B1 or WO 96 12759 (U.S. Pat. No. 5,451,615) A2.

Vegetable-oil-based polyols are also described in various patent specifications, for example in WO 2006/094227 (US 2007-0037953), WO 2004/096882 (U.S. Pat. No. 7,615,658), US 2002/0103091, WO 2006/116456 (US 2006-0264524) and EP 1 678 232 (US 2005-0070620).

Polyisocyanates that can be used for the production of the polyurethane foams are the compounds conventionally used in this sector for the respective types of foam, for example as described in EP 1 712 578 A1 (US 2006-0235100), EP 1 161 474 (US2005-0014857), WO 058383 A1, US 2007/0072951 A1, EP 1 678 232 A2 (US 2005-0070620) and WO 2005/085310 (US 2007-0270518).

Production of a foam requires a blowing agent. Any of the known blowing agents can be used. This material can be water as chemical blowing agent which liberates carbon dioxide via reaction with the isocyanates. However, it is also possible to use carbon dioxide directly as physical blowing agent, or to use other blowing agents which have a suitable boiling point and therefore vaporize during the exothermic reaction. Examples of these are halogenated hydrocarbons or hydrocarbons such as pentane isomers. Combinations of the two methods are also possible.

The urethane foam reaction is usually initiated and/or controlled via suitable catalysts. Examples of those used here are tertiary amines or metal-containing catalysts (containing, for example, tin compounds, potassium compounds, zinc compounds).

Stabilizers that can be used are the substances known from the prior art. The materials here are mostly organically modified siloxanes such as those described in EP 0839852 (U.S. Pat. No. 6,265,456), WO 2005/118668, US 20070072951 A1, DE 2533074 (U.S. Pat. No. 4,042,540), EP 1537159 (US 2006-0167125), EP 1712576 (US 2006-0229375), EP 1544235 (U.S. Pat. No. 7,183,330), EP 0533202, U.S. Pat. No. 3,933,695, EP 0780414 (U.S. Pat. No. 5,807,903), DE 4239054 (U.S. Pat. No. 5,321,051), DE 4229402 (U.S. Pat. No. 5,306,737), DE 102004001408 (US 2005-0176837), EP 0867465 (U.S. Pat. No. 5,844,010) and in the documents cited therein.

Flame retardants that can be used are the substances known from the prior art. These are often phosphorus-containing compounds, preferably phosphoric esters. These are marketed inter alia by LANXESS with product names Disflamoll® and Levagard® or by Clariant with product name Exolit® or Hordaphos®.

The auxiliaries and additives that can be used for the production of the polyurethane foams, e.g. catalysts, stabilizers, flame retardants, blowing agents, are likewise the components known from the prior art.

G. Oertel (Ed.): “Kunststoffhandbuch” [Plastics Handbook], Volume VII, C. Hanser Verlag, Munich, 1983, Houben-Weyl: “Methoden der organischen Chemie” [Methods of Organic Chemistry], Volume E20, Thieme Verlag, Stuttgart 1987, (3), pages 1561 to 1757, and “Ullmann's Encyclopedia of Industrial Chemistry” Vol. A21, VCH, Weinheim, 4^{th} Edition, 1992, pages 665 to 715 give a summary of the prior art, of the raw materials used and of the processes that can be used.

The compatibilizers of the invention and their use are described below by way of example, but there is no intention that the invention be restricted to these examples. Where ranges, general formulae or classes of compounds are stated below, the intention is that these encompass not only the particular ranges or groups of compounds that are explicitly mentioned but also all of the sub-ranges and sub-groups of compounds that are obtainable by extracting individual values (ranges) or compounds. Where documents are cited for the purposes of the present description, the intention is that their content be entirely incorporated into the disclosure of the present invention.

The claims characterize further subject matter of the invention.

### INVENTIVE EXAMPLES

The examples below are intended to illustrate the invention, but they do not represent a restriction of any kind.

For the purposes of this application, compositions are regarded as homogeneous if by way of example they exhibit no phase separation amounting to more than 3 ml on standing in a 100 ml measuring cylinder for the stated period (in hours) at the stated room temperature. A result of this type is termed “good”. The result is termed “very good” if homogeneity is retained over a longer period or the amount of phase-formation is substantially less than 50% of the prescribed value. The result is termed “satisfactory” if the amount of phase-formation is more pronounced and greater than 150% of the prescribed value, and it is termed “unsatisfactory” if it is more than 200%.

In general terms, it has been found that shelf life becomes poorer at higher temperature. However, industrial operations during transport or storage of a polyol mixture are often not carried out at room temperature, the materials instead being heated to from 30 to 40° C. The experiments were therefore carried out at temperatures of 20 and 40° C.

### Production of the Compatibilizers:

### Inventive Example 1

800 g of polyglycol M 2000 (product of Clariant) were used as initial charge at 75° C. in a kneader (List CRP 2.5 batch kneader), and 200 g of Aerosil R 972 (product of Evonik Degussa) were added over a period of 1 hour. Kneading was then continued at 70° C. for 2 hours. Cooling to room temperature gives a solid, or granules.

### Inventive Example 2

113 g of Aerosil R 974 and 1387 g of a glycerol-started polyol with molar mass 6000 g/mol, based on 85% of propylene oxide and 15% of ethylene oxide are mixed at 25° C. in a beaker using a dissolver disc at 2000 rpm until a homogeneous paste is produced.

### Inventive Example 3

610 g of Aerosil R 972 (from Evonik Degussa) and 390 g of polyethylene glycol 600 (PEG 600, from Clariant) were processed as described in inventive example 1, to give granules.

### Inventive Example 4

450 g of Aerosil R 972 (from Evonik Degussa) and 650 g of PEG 2000 (from Clariant) were processed as described in inventive example 1, to give granules.

### Inventive example 5

200 g of Aerosil R 805 (from Evonik Degussa) and 800 g of PEG 2000 (from Clariant) were processed as described in inventive example 1, to give granules.

### Inventive Example 6

475 g of Aerosil R 972 (from Evonik Degussa) and 525 g of TAGAT R 200 (from Evonik Goldschmidt) were processed as described in inventive example 1, to give granules.

### Inventive Example 7

10.65 g of Aerosil R 805 and 89.35 g of a glycerol-started polyol with molar mass 6000 g/mol, based on 85% of propylene oxide and 15% of ethylene oxide are mixed at 25° C. in a beaker using a dissolver disc at 2000 rpm until a homogeneous clear paste is produced.

### Inventive Example 8

150 g of Aerosil R 805 and 850 g of butyl diglycol are mixed in a beaker using a dissolver disc at 2000 rpm until a homogeneous paste is produced.

### Inventive Example 9

310 g of Aerosil® R 805 and 1000 g of TEGOSOFT® M are mixed using a dissolver disc at 5000 rpm, and then 12.4 g of octyltrimethoxysilane are added and mixing is continued. The mixture is then charged to a bead mill (Lab-Star from NETSCH), where it is processed at 1500 rpm and at a temperature of 45° C. for 6 hours, using grinding beads of size from 1.0 to 1.2 mm. The product is an opaque to translucent viscous liquid.

### Inventive Example 10

56.7 g of TEGOSOFT® M are used as initial charge, and 22.1 g of Aerosil® R 972 are progressively incorporated using a dissolver disc, initially at 500 rpm. The product is a thixotropic liquid, which is homogenized by repeated brief increasing of the rotation rate to 5000 rpm. After addition of the Aerosil has ended, the mixture is finally homogenized for 15 minutes at 5000 rpm. 1.32 g of octyltrimethoxysilane are then added, and the mixture is homogenized for 6 minutes using an ultrasound sonotrode (rating 60 W). The product is an opaque to translucent liquid.

### Inventive Example 11

### Use of Flame Retardant as Carrier Medium

By analogy with inventive example 10, 24 g of Aerosil® R 8200 are incorporated into a mixture composed of 39 g of TEGOSOFT® M and 12 g of tris(2-chloroisopropyl)phosphate, and the mixture is then treated with 1.4 g of octyltrimethoxysilane. The product is an opaque to translucent liquid.

### Inventive Example 12

### Addition of a Foam Stabilizer to the Compatibilizer

By analogy with inventive example 10, 24 g of Aerosil® R 974 are incorporated into a mixture composed of 39 g of TEGOSOFT® M and 12 g of tris(2-chloroisopropyl)phosphate, and the mixture is then treated with 1.4 g of octyltrimethoxysilane, and finally 2 g of an organomodified siloxane are added: TEGOSTAB® B 8469 from Evonik Goldschmidt. The product is an opaque to translucent liquid.

### Use of the Compatibilizers in Polyol Mixtures:

Storage trials were carried out with various polyol mixtures.

### Raw Materials Used:

Polyol A: polyester polyol: Stepanpol PS 2352 (from Stepan)
Polyol B: polyester polyol: Terol 563 (from Oxid)
Polyol C: polyester polyol: Terate 2541 (from Invista)
Polyol D: castor oil (Alberding+Boley, Krefeld)
Polyol E: PO-rich polyether polyol: Voranol CP 3322 (from Dow)
Polyol F: EO-rich polyether polyol, Voranol CP 1421 (from Dow)
Polyol G: vegetable-oil-based polyol based on soya oil
Polyol H: low-temperature foam polyether polyol: Hyperlite®
Polyol 1629 (from Bayer)
Polyol I: palm-oil-based polyol
Polyol J: low-temperature foam polyether polyol: Desmophen VP.
PU 10WF15 (from Bayer)

The compatibilizers from inventive examples 1 to 12 were incorporated via stirring of the pastes or granules into the corresponding polyol mixtures, using conventional laboratory stirrer devices, such as magnetic stirrer rods or blade stirrers. (High shear forces are therefore not used here, as is the case in the production of the compatibilizers).

If necessary, the mixtures were heated to temperatures up to 70° C. in order to incorporate the compatibilizers. The mixtures were then stored at the stated temperatures and checked for stability.

Table 1 collates the polyol components used and the contents of these, the respective compatibilizers and the contents of these, the storage temperature, and the stability of the mixtures. Stability was assessed visually over the following periods: 2 h, 4 h, 8 h, 16 h, 24 h, 36 h, 48 h, and then at 24 h intervals, with qualitative assessment.

TABLE 1

| | Polyol, | Polyol, | Compatibilizer, | | |
|---|---|---|---|---|---|
| Ex. | parts | parts | parts | Temp. | Stability |
| 13 | A, 78 | D, 20 | Ex. 1, 2 | 20° C. | 120 h, good |
| 14 | B, 78 | D, 20 | Ex. 4, 4 | 20° C. | 120 h, good |
| 15 | C, 78 | D, 20 | Ex. 12, 4 | 20° C. | 120 h, good |
| 16 | E, 77 | F, 20 | Ex. 6, 3 | 40° C. | 48 h, very good |
| 17 | J, 48 | I, 48 | Ex. 2, 4 | 40° C. | 48 h, good |
| 18¹) | E, 50 | I, 50 | Ex. 1, 2 | 40° C. | 48 h, good |
| 19¹) | E, 50 | I, 50 | Ex. 10, 4 | 40° C. | 48 h, good |
| 20 | H, 90 | F, 10 | Ex. 2, 4 | 20° C. | 48 h, good |
| 21¹) | E, 50 | G, 50 | Ex. 3, 4 | 40° C. | 48 h, good |
| 22 | A, 78 | D, 20 | Ex. 5, 2 | 40° C. | 48 h, good |
| 23 | E, 77 | F, 20 | Ex. 7, 3 | 20° C. | 48 h, good |
| 24 | E, 77 | F, 20 | Ex. 8, 3 | 20° C. | 48 h, good |
| 25 | E, 77 | F, 20 | Ex. 9, 3 | 20° C. | 48 h, good |
| 26 | A, 78 | D, 20 | Ex. 11, 2 | 20° C. | 120 h, good |
| 27 | B, 78 | D, 20 | Ex. 12, 4 | 20° C. | 120 h, good |
| Comp. 1 | A, 80 | D, 20 | | 20° C. | <16 h, |
| | | | | | unsatisfactory |
| Comp. 2 | B, 80 | D, 20 | | 20° C. | <16 h, |
| | | | | | unsatisfactory |
| Comp. 3 | C, 80 | D, 20 | | 20° C. | <16 h, |
| | | | | | unsatisfactory |
| Comp. 4 | J, 50 | I, 50 | | 20° C. | <16 h, |
| | | | | | unsatisfactory |
| Comp. 5¹) | E, 50 | I, 50 | | 20° C. | <4 h, |
| | | | | | unsatisfactory |
| Comp. 6¹) | E, 50 | G, 50 | | 20° C. | <16 h, |
| | | | | | unsatisfactory |
| Comp. 7²) | A, 80 | D, 20 | | 20° C. | 24 h, |
| | | | | | unsatisfactory |
| Comp. 8³) | B, 80 | D, 20 | | 20° C. | 24 h, |
| | | | | | unsatisfactory |

¹)4 parts of water were also admixed with the mixture.
²)2 parts of TAGAT R 200 were also admixed with the mixture.
³)2 parts of PEG 2000 were also admixed with the mixture.

The inventive examples show that the shelf life of the polyol mixtures can be markedly improved by use of the compatibilizers of the invention. The comparative examples, where no compatibilizers, or compatibilizers not of the invention, were used, exhibit markedly shorter shelf life.

### Production of PU Foams:

### Testing in Rigid Foam:

### Inventive Example 28

The following foam formulation was used to test the performance characteristics of the formulations of the invention:

| Component | Amount used |
|---|---|
| Polyol* | 100 parts |
| DMCHA | 1.5 parts |
| Water | 2 parts |
| TCPP | 15 parts |
| Kosmos 75 MEG | 3.5 parts |
| n-Pentane | 12 parts |
| TEGOSTAB B 8469 | 2 parts |
| MDI** | 205.7 parts |

*Mixture of inventive example 13 after storage for 36 h
**polymeric MDI, 200 mPa*s, 31.5% NCO, functionality 2.7
DMCHA: dimethylcyclohexylamine used as aminic catalyst,
TCPP: trischloropropyl phosphate, flame retardant,
Kosmos 75 MEG: metal-based catalyst from Evonik Goldschmidt,
TEGOSTAB B 8469: foam stabilizer from Evonik Goldschmidt.

The foaming processes were carried out by the manual mixing method. For this, polyol, catalysts, water, flame retardant and blowing agent were weighed into a beaker and mixed at 1000 rpm for 30 s using a disc stirrer (diameter 6 cm). The amount of blowing agent lost by evaporation during the mixing procedure was determined via reweighing and replaced. The MDI was then added, and the reaction mixture was stirred at 3000 rpm for 5 s, using the stirrer described, and immediately transferred to a paper-lined box mould measuring 27 cm×14 cm×14 cm. Various test specimens were cut from the foam after it had hardened, and the materials were assessed and tested as follows:

The foam had a very fine cell structure. There were no bottom-zone defects.

Density: 23.3 kg/m³

Lambda value (parallel to direction of rise): 24.9 mW/m*K

Lambda value (perpendicular to direction of rise): 23.1 mW/m*K

10% compression hardness (parallel to direction of rise): 187 kPa

10% compression hardness (perpendicular to direction of rise): 55 kPa

Closed-cell factor: 84.8%

### Comparative Example 9

The polyol component used comprises the polyol mixture from comparative example 1 after storage for 12 h, and the foam formulation described in inventive example #29 was used. Signs of collapse were apparent during the foaming process. The foam product obtained was of very poor quality.

### Testing in Flexible Foam:

### Inventive Example 29

The polyol mixtures of the invention were studied in a typical high-temperature flexible polyurethane foam formulation:

Formulation for producing the high-temperature flexible polyurethane foams:

100 parts by weight of the polyol mixture from inventive example 18, 4.0 parts by weight of water (chemical blowing agent), 1.0 part by weight of TEGOSTAB B 2370, 0.2 part by weight of dimethylethanolamine, 0.2 part by weight of tin catalyst (Kosmos 19 from Evonik Goldschmidt), 2.5 parts by weight of methylene chloride (additional physical blowing agent), 53 parts by weight of isocyanate (tolylene diisocyanate, TDI-80) (ratio of isocyanate groups to isocyanate-consuming reactive groups=1.15)

### Method:

Polyol mixture, water, catalysts and stabilizer were used as initial charge in a paperboard beaker and mixed using a disc stirrer (45 s at 1000 rpm). The methylene chloride was then added and the mixture was again mixed for 10 s at 1000 rpm. The isocyanate (TDI-80) was then added and the mixture was again stirred for 7 s at 2500 rpm. The mixture was then charged to a box with basal area 15 cm×15 cm. The full rise height was then measured by means of an ultrasound height-measurement system during the foaming process. The full rise time is the time required for the foam to reach its maximum rise height. Settling is the term used for the amount of sag of the surface of the foam after discharge of the high-temperature flexible polyurethane foam. Settling is measured here 3 minutes after discharge. Density was measured to DIN EN ISO 845 and DIN EN ISO 823. The number of cells was counted at three locations by means of a lens using a scale, and the values were averaged.

The Results Obtained were as Follows:

Full rise time: 195 s

Full rise height: 21 cm

Settling: 0.1 cm

Number of cells: 9 cells/cm

### Testing in Moulded Foam:

### Inventive Example 30

### The Following Formulation was Used:

100 parts of polyol mixture as described in inventive example 20, 0.5 part of TEGOSTAB® B 4113, 3 parts of water, 2 parts of triethanolamine, 0.6 part of TEGOAMIN® 33 and 0.2 part of diethanolamine, and a mixture composed of 18.5 parts of polymeric MDI (44V20 from Bayer) and of 27.7 parts of TDI (tolylene diisocyanate, T80).

The foam was produced in the known manner, by mixing all of the components except for the isocyanate in a beaker and then adding the isocyanate and incorporating it at a high stirrer rotation rate. The reaction mixture was then charged to a mould in the shape of a cuboid with dimensions 40×40×10 cm that had been heated to a temperature of 40° C., and the composition was permitted to harden for 10 minutes. The compressive forces were then measured, by compressing the foam 10 times to 50% of its height, and using the 1^{st} value measured (CF 1 in Newtons) as a measure of the open-cell factor of the foam. The compression process was then completed (manually) so that the 11^{th} value measured (CF 11 in Newtons) could be used to determine the hardness of the foam at the end of the compression process. The foam was then cut open in order to make assessments of the skin and edge zone and determine the number of cells (CN).

The Results Obtained were as Follows:

CF 1: 1045 N

CF 11: 137 N

CN: 10 cells per cm

The assessment of skin and edge zone was “good”.

This corresponds to foam quality that meets the technical requirements.

The results of the foaming process show that the mixtures of the invention can be used to produce good-quality PU foams without any disadvantages due to problems with mixing of the polyols. The compatibilizers of the invention have no adverse effect on the foaming process.

Having thus described in detail various embodiments of the present invention, it is to be understood that the invention defined by the above paragraphs is not to be limited to particular details set forth in the above description as many apparent variations thereof are possible without departing from the spirit or scope of the present invention.

1. A compatibilizer for mutually immiscible polyol compositions, characterized in that it comprises dispersed particles in a carrier medium.

2. The compatibilizer according to claim 1 comprising particle dispersions in a carrier medium, for the compatibilization of polyol compositions comprising at least two mutually immiscible polyols, characterized in that particles are used which assume an interface-stabilizing function.

3. The compatibilizer according to claim 1, characterized in that the particles have been selected from the group of the semimetal oxides, metal oxides, mixed oxides, and of the nitrides, carbides, hydroxides, carbonates, silicates, silicone resins, silicones and/or silica and/or organic polymers.

4. The compatibilizer according to claim 1, characterized in that the particles have been surface-modified.

5. The compatibilizer according to claim 4, characterized in that the particles present have been surface-modified with at least one compound from the group of the silanes, siloxanes, quaternary ammonium compounds, cationic polymers and fatty acids or anions of these.

6. The compatibilizer according to claim 1, characterized in that the particles present are preferably, in at least one dimension, nanoscale or nanostructured, or in that nanoobjects are used.

7. The compatibilizer according to claim 1, characterized in that co-emulsifiers are used in the form of cationic, nonionic, amphoteric or anionic surfactant substances that are adsorbed onto the particles.

8. The compatibilizer according to claim 1, characterized in that they are free from non-particulate co-emulsifiers.

9. The compatibilizer according to claim 1 in the form of a paste or of granules.

10. A process for the production of the compatibilizers according to claim 1, characterized in that high shear forces are used to incorporate the particles into the carrier medium.

11. The process for the production of the compatibilizers according to claim 10, characterized in that the carrier medium is miscible with at least one of the polyol components.

12. The process according to claim 10, characterized in that the carrier medium used comprises high-molecular-weight polyols which, at room temperature, have viscosity greater than 5 mPas or are solid.

13. A homogeneous polyol mixtures, comprising the compatibilizers according to claim 1 and further auxiliaries and additives.

14. The homogeneous polyol mixtures according to claim 13, comprising polyols based on renewable raw materials, in particular vegetable-based polyols, if appropriate in a mixture with polyesterdiols or with polyester polyols.

15. The homogeneous polyol mixtures according to claim 13, comprising at least two mutually immiscible polyether polyols with different content of polyethylene oxide units for use in the production of polyurethane foams and/or of polyisocyanurate foams and/or of polyurea foams.

16. A process of making polyurethane foams and/or polyisocyanurate foams and/or polyurea foams, comprising a step wherein the compatibilized polyol mixtures according to claim 13 is added to the polyol component.

17. The process of claim 16, wherein the polyurethane foams and/or polyisocyanurate foams are rigid polyurethane foams and/or rigid polyisocyanurate foams.

18. The process of claim 16, wherein the polyurethane foams and/or polyisocyanurate foams are flexible polyurethane foams and/or flexible polyisocyanurate foams.
